(19) United States
(12) Patent Application Publication
(10) Pub. No.: US 2009/0067635 A1
(43) Pub. Date: Mar. 12, 2009

(54) APPARATUS AND METHOD FOR REPRODUCTION OF STEREO SOUND

(75) Inventor: EDWARD STUART FLETCHER, Torquay (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Airsound LLP, Torquay (GB)

(21) Appl. No.: 12/196,252

(22) Filed: Aug. 21, 2008

(30) Foreign Application Priority Data
Feb. 22, 2006 (GB) 0603545.5
Feb. 21, 2007 (GB) PCT/GB2007/000599

(51) Int. Cl. H04R 5/00

(52) U.S. Cl. 381/17

(57) ABSTRACT

An apparatus and method for reproducing stereo sound. A transducer (14) is provided for reproducing two audio signals which are substantially out of phase with each other. Means, such as duct (11), are associated with the transducer to conduct at least one of the audio signals to a location such that the two substantially out of phase signals are transmitted from respective spaced apart locations. The duct (11) may lead to ports (4). These may be elongate and arranged to transmit sound across a flat surface. A second transducer (8) may be provided for transmitting a second audio signal. A conventional two channel stereo audio signal may be reproduced by the sum and difference system.

### CROSS-REFERENCES TO RELATED APPLICATIONS

This application claims priority to PCT Application No. PCT/GB2007/000599; filed on Feb. 21, 2007; which claims priority to GB Application No. 0603545.5, filed on Feb. 22, 2006, commonly assigned, and of which is hereby incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to an apparatus and method of reproducing stereo sound, and particularly to a method and apparatus for reproduction of stereo sound from a two channel stereo sound signal.

Stereo sound recording and reproduction employs stereographic projection to encode the relative position of sound sources recorded, and aims to reproduce the sound with a sense of those relative positions. A stereo system can involve two or more channels, but two channels systems dominate for audio recording. The two channels (usually known as left and right) convey information relating to the sound field in front of the listener. By far the most popular means for reproducing two channel stereo signals is to broadcast the channels via two respective, spaced apart, left and right loudspeakers.

Despite its popularity, though, there are disadvantages with this system. Most commercial two channel stereo sound recordings are mixed for optimum reproduction by loudspeakers spaced about 1.6 metres apart. In reality, this is rarely possible, especially where it is desired to reproduce stereo sound from a single unit. In any event, however a recording is mixed, the closer the loudspeakers used to transmit the left and right channels are together, the poorer the stereo effect reproduced.

Also, for optimum perception of stereo effect the listener should be located at the apex of an equilateral triangle made by the pair of loudspeakers and the listener. In reality, thought, it is often inconvenient or impossible for a listener to adopt or maintain this position and, of course, it is impossible for multiple listeners to listen from the same position.

An alternative system for reproduction of a two channel stereo signal which should overcome some of the above disadvantages has been proposed. This system, which shall be referred to as the sum and difference system, is disclosed in U.S. Pat. No. 3,588,355. This document discloses a stereophonic loudspeaker system comprising two pairs of loudspeakers. Each pair is oriented with their axes at right angles to each other and substantially equidistant from the point of intersection of the axes. The speakers are so arranged that one speaker of each pair faces the listener and the other speaker has its axis substantially perpendicular to the listener. Means are provided for matrixing left and right two-channel stereo signals to provide a sum signal and a difference signal. The sum signals are applied in phase to the speakers whose axes are directed toward the listener, and the difference signals are applied to the speakers whose axes are positioned at right angles with respect to the direction of the listener, the difference signals to the two perpendicular speakers being applied 180° out of phase with each other. As a result, a stereophonic sound effect should be produced by the system.

Whilst intended to overcome the problems associated with the use of spaced apart speakers the arrangement of U.S. Pat. No. 3,558,355 has not entered widespread use. This is thought to be because there are practical difficulties with the disclosed apparatus which result in the actual sound quality and perceived stereo effect obtained failing below what might theoretically be expected.

### BRIEF SUMMARY OF THE INVENTION

The present invention seeks to provide improved apparatus for the reproduction of stereo sound using the sum and difference system. It is an object of some, but not all, embodiments of the invention to provide for reproduction of stereo sound by compact, especially hand held, apparatus.

According to a first aspect of the present invention there is provided apparatus for reproduction of stereo sound comprising a transducer for reproducing two audio signals, substantially out of phase with each other, from a single input and means associated with the transducer to conduct at least one of the two audio signals to a location such that the two substantially out of phase signals are transmitted from respective spaced apart locations.

According to a second aspect of the present invention there is provided a method of reproducing stereo sound comprising the steps of:

providing a transducer;

driving the transducer with a single input, thereby to produce two audio outputs substantially out of phase with each other;

providing means for conducting an audio signal and associating it with the transducer to conduct one of the two out of phase signals to a location such that the two out of phase signals are transmitted from respective spaced apart locations.

It is thought that the sum and difference system of stereo sound reproduction works by the broadcast audio sum signal being modified by the broadcast difference signal by varying amounts at different locations to recreate the original recorded sound field, or an approximation of it. Reproducing the mono, sum, signal is relatively straight forward. However reproducing the two out of phase difference signals with sufficient fidelity to enable a stereo effect to be achieved is problematic. The out of phase signals are apt to interfere with an cancel each other out. When these signals are produced by two separate sources, spacing of the sources and any different physical performance of the sources can introduce unknown phase and other differences between the out of phase signals. The whole effect is to impair the quality of the difference signals to an unsatisfactory level of overall performance.

By using a single transducer to produce both out of phase difference signals and by conducting at least one of those signals such that the two signals are transmitted from spaced apart locations these problems are overcome, to at least reduced.

Separating the points of transmission of the two signals reduces their tendency to cancel each other out. The greater the distance, the greater the reduction in cancellation. Using a single transducer inherently leads to the two signals being 180° out of phase, as does originally generating the two signals at the substantially the same point in space.

The transducer may be a bi-directional loudspeaker and in particular a dipole loudspeaker. It may comprise a driver arranged to drive a loudspeaker element, such as a diaphragm which may be of any suitable shape, for example, frusto-conical, or substantially flat. The transducer may be arranged to transmit the two out of phase signals in substantially opposite directions. The out of phase signals are preferably substantially 180° out of phase.

The means associated with the transducer for conducting at least one of the audio signals may be a duct. Preferably the transducer is disposed in a duct, the duct having two openings, and arranged such that one out of phase signal is transmitted via one of the openings and the other out of phase signal is transmitted via the other opening. Preferably the openings face in substantially opposite directions. The cross-sectional area of the openings may be less than that of the remainder of the duct or ducts.

The apparatus may comprise a housing. The housing preferably has two openings via which the two out of phase signals are transmitted, respectively. The housing is preferably arranged to be placed on or adjacent a flat surface, and the openings are preferably disposed on the housing such that when the housing is placed on or adjacent a flat surface, the openings lie adjacent that surface. Alternatively, or additionally, the housing may comprise a flat surface or surfaces extending from adjacent the or each opening. Arranging so that the or each opening can lie adjacent a flat surface enables the surface effect to be exploited. As discussed further below, arranging for the out of phase signals to be broadcast along a flat surface enhances them, and consequently the overall sense of width and depth of the produced sound of a sum and difference system.

Where the out of phase audio signals are transmitted via openings, the openings are preferably elongate, and at least one long edge of the openings is substantially straight. Where the apparatus comprises a housing this straight edge is preferably disposed adjacent an edge of the housing. The ratio of length to width of the opening may be in the range 10:1 to 2:1 or in the range 3:1 to 5:1. An elongate opening better enables an audio signal to be transmitted across a flat surface.

The apparatus may include a second transducer, and the method the use of a second transducer, to transmit a second audio signal. The second transducer may be a loudspeaker and is preferably arranged to transmit a signal in a direction between those of the two out of phase signals. Most preferably the two out of phase signals are transmitted in opposite directions along the same axis and the second transducer is arranged to transmit an audio signal in a direction substantially perpendicular to that axis.

The apparatus and method may be used to reproduce a two channel stereo signal using the sum and difference system. In this case the transducer for reproducing two out o phase signals (“the first transducer”) is driven with a signal comprising and preferably consisting exclusively of the difference of the two stereo channels and the second transducer is driven with a signal comprising or consisting exclusively of the sum of the two stereo channels.

The apparatus may include a sum and difference matrix to achieve this.

The difference signal may be filtered to reduce the amplitude of low frequencies. Low frequencies included in the sum signal may be boosted. The apparatus may include a high pass filter and/or a base lift compensation circuit. It is found that boosting low frequencies transmitted by the second transducer and reducing to eliminating low frequencies transmitted by the first transducer leads to a further improvement in the depth and feel of the reproduced sound. This is also discussed further below.

The apparatus may be comprised in a housing sized to be held comfortably to the hand. In particular it may be comprised in a hand held device, such as a mobile (cell) telephone handset, an audio player such as an MP3 player, hand held computer, communicator, pager or the like. Such devices tend to be generally flat and elongate having a major plane extending through the device. For such devices, where space is limited, and for other generally flat housings the first and second transducers may both lie substantially parallel to the major plane of the device. The two transducers may be disposed side to side. The first transducer is preferably arranged so that the two out of phase signals are directed to respective ports on opposite sides of the device. The ports preferably lie on a common axis. The ports are preferably elongate. Edges, preferably long edges, of the ports preferably lie adjacent an edge of the sides of the device. The second transducer is preferably arranged to transmit a signal via a port facing in a direction substantially perpendicular to the direction of the ports associated with the first transducer.

The apparatus could be provided in a housing arranged to receive a device intended to provide a stereo signal to drive the transducers. In particular the device may be comprised in a docking station for an MP3 player or other portable music playing device.

### BRIEF DESCRIPTION OF THE DRAWINGS

In order that the invention may be more clearly understood embodiments thereof will now be described, by way of example, with reference to the accompanying drawings of which:

FIG. 1 is a perspective view of a loudspeaker unit according to the invention;

FIG. 2 is a cross-sectional view, taken along broken line II-II of the unit of FIG. 1, together with a block diagram of electronic circuitry associated with the unit;

FIG. 3 is a cross-sectional view, taken along the broken line III-III of the unit of FIG. 1;

FIG. 4 is a cross-sectional view, taken along the broken line IV-IV of the unit of FIG. 1;

FIG. 5 is a cross-sectional view from above of an alternative embodiment of a loudspeaker unit according to the invention;

FIG. 6 is a cross-sectional view from above of a further embodiment of a loudspeaker unit according to the invention;

FIG. 7 is a perspective view of a mobile (cell) telephone handset incorporating apparatus according to the invention;

FIG. 8 is a cross-sectional view taken along the broken line VIII-VIII of the handset of FIG. 7, together with a block diagram of associated electronic circuitry;

FIG. 9 is a cross-sectional view taken along the broken line IX-IX of the handset of FIG. 7;

FIG. 10 is a cross-sectional view taken along the line X-X of the handset of FIG. 7;

FIG. 11 is a perspective view of a music player docking station incorporating apparatus according to the invention;

FIG. 12 is a cross-sectional view taken along the line XII-XII of docking station of FIG. 11 (from the front); and

FIG. 13 is a cross-sectional view taken along the line XIII-XIII of the docking station of FIG. 12 (from the side).

### DETAILED DESCRIPTION OF THE INVENTION

In the following drawings where the terms front, rear, top, bottom and like terms are used they refer to directions relative to the apparatus as illustrated and/or as it is intended to be used. The terms are used for convenience only and are not intended to be otherwise limiting. In the drawings, like reference numerals are used throughout to identify like or corresponding components.

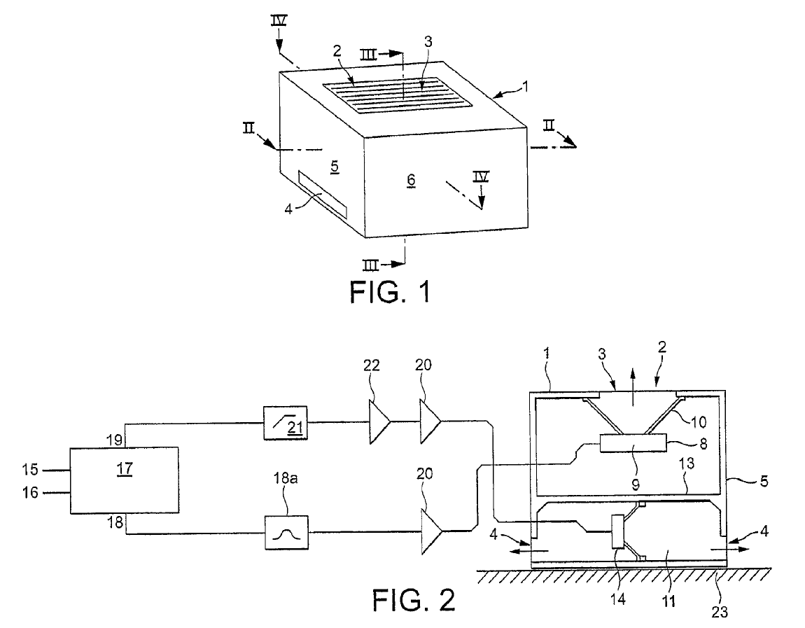

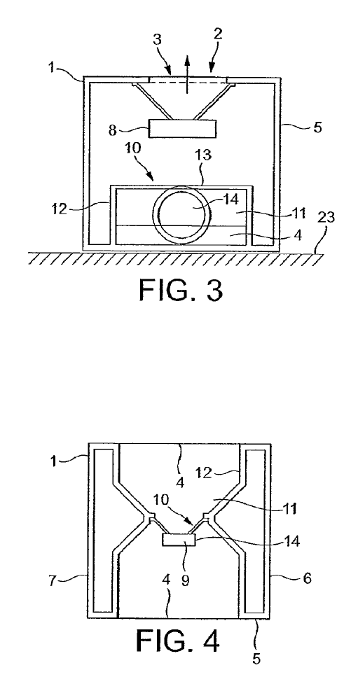

Referring to the drawings, FIGS. 1 to 4 show a sum and difference loudspeaker unit according to the invention. The unit comprises a housing 1 which is, externally, generally cuboidal in shape. The housing is manufactured from hardboard, but could be manufactured from any other suitable material such as is usually employed for the manufacture of loudspeaker housings. A generally rectangular aperture 2 is formed approximately centrally in the top of the housing. A grille 3, or other cover substantially transparent to sound, extends across the aperture.

A respective elongate rectangular aperture 4 is formed in each of the two opposite sidewalls 5 of the housing 1. The ratio of the length to width of the aperture is about 4:1, and each aperture 4 is located approximately mid-way along the lower edge of its sidewall 5, with one of the long sides of the aperture extending substantially parallel and closely adjacent to the lower edge of the sidewall 5. Although not shown, each elongate aperture 4 could be provided with a cover which is substantially transparent to sound.

The front 6, rear 7 and underside surfaces of the housing are not provided with any apertures.

A single loudspeaker 8 is mounted to the underside of the top of the unit beneath the aperture 2. The loudspeaker is of a conventional type and comprises a driver 9 arranged to drive a diaphragm 10 of generally frustroconical shape. The loudspeaker 8 is arranged to transmit an audio signal through the aperture 2 in the top of the unit.

A duct 11 extends from the elongate aperture 4 in one side wall 5 to the corresponding aperture in the opposite sidewall. The duct 11 is constructed from sidewalls 1 and a top 13. The sidewalls 12 extend upwards from the base of the housing just outside the width of each elongate aperture 4, so that each aperture opens only into the duct 11. The inner face of each duct sidewall 12, that is to say the face which faces the other sidewalls, extends initially away from each elongate aperture 4 in a direction substantially parallel to the front 6 and rear 7 surfaces of the housing 1, that is to say a direction substantially perpendicular to the outside surfaces of the sidewalls 5 of the housing. Towards the centre of the housing each duct sidewall 12 turns through an angle of about 45° so that the two sidewalls approach each other, but do not touch. This results in each sidewall 12 consisting of two spaced apart parallel sections at opposite ends, joined by two angled portions which form two sides of a triangle. So far as the interior of the duct 11 is concerned, each end has a width substantially the same or greater than that of the elongate apertures 4, but it then narrows to a narrowest point just offset from the mid-point between opposite sides of the housing.

The duct sidewalls 12 extend from the base of the housing 1 to a height approximately three times that of the elongate apertures 4. The top 13 of the duct 11 extends between the duct and housing sidewalls 12, 5 substantially isolating the inside of the duct 11 from the remainder of the interior of the housing 1. The top surface of the top 13 of the duct is substantially that and extends substantially parallel to the top and base of the housing 1. The bottom surface of the top of the duct 13 is substantially flat and extends substantially parallel to the top and base of the housing 1 towards its centre, but at its respective opposite ends it is angled downwards so that it meets the sidewalls 5 of the housing about mid-way between a point on the inside of the sidewalls at the height of the underside of the centre at the top of the duct 13 and the upper edges of the elongate apertures 4. The cross-sectional area of the narrowest part of the duct 13 is less than that of one of the elongate apertures.

Mounted at, and closing with a substantially air-tight seal, the narrowest part of the duct 13 is a loudspeaker 14. This loudspeaker also comprises a driver 9 and a generally frustroconical diaphragm 10. The loudspeaker 14 is arranged to transmit respective audio signals, 180° out of phase with each other, through the respective opposite elongate apertures 4.

The loudspeaker unit is associated with the electronic circuit shown in FIG. 2. It will be appreciated that the circuit components could be housed in the housing 1 or separately.

The circuit comprises two inputs 15, 16 connected to a sum and different matrix 17. The sum and difference is arranged to produce two outputs: a sum output at 18 which comprises the sum of the inputs at 15 and 16 (15+16); and a difference output at 19 which comprises the difference of the inputs at 15 and 16 (15−16).

The sum output 18 is connected to a bass lift compensation circuit 18a. This adds a gain of about 3 dB to low frequency components of the signal, typically frequencies between n40 and 500 Hz. The output of the bass lift compensation circuit is connected via a power amplifier 20 to the loudspeaker 8 mounted beneath the aperture 3 in the top of the housing 1 (“the mono loudspeaker”).

The different output 19 is connected to a high pass filter 21 operative to reduce the amplitude of frequencies below 100 Hz by at least 3 dB. The filtered signal is then subjected to a gain make up of about 4 dB by an amplifier 22, the output of which is connected via a power amplifier 20 to the loudspeaker 14 mounted in the duct 11 (“the dipole loudspeaker”).

The power amplifier 20 associated with the dipole loudspeaker need only have around 10 to 20% of the power output of that associated with the mono loudspeaker.

The loudspeaker unit is intended to reproduce a conventional two channel stereo sound signal using the sum and difference system. In use the unit is preferably placed on a flat surface 23 which extends around all sides of the unit. The two channels (left and right) of a stereo sound signal are then supplied to the two inputs 15 and 16 of the sum and different matrix respectively. Listeners should ideally be located towards the front of the unit, but could be located behind the unit. Although the unit enables listeners to appreciate the depth and width effect of a stereo recording over a wide area this will best be detected at locations on or near an axis extending through the dipole loudspeaker in a direction perpendicular to the axis of the duct 13. The depth and width effect will be worst at or near locations lying on an axis extending through the duct 13.

The described loudspeaker unit conveys significant advantages over conventional sum and difference loudspeaker arrangements. The duct 13 physically separates the points from which the two out of phase audio signals produced by the dipole loudspeaker are transmitted. This significantly reduces interference between these signals. Such interference serves to cancel out the signals, resulting in a loss of spatial information. For best performance from a sum and difference loudspeaker system it is important that the difference signal is of good quality when it meets the sum signal.

The elongate apertures 4 are positioned adjacent an edge of the unit which, in use, is intended to be placed adjacent a flat surface, in this particular case a floor or the top of a piece of furniture. Locating the apertures in this way exploits the surface effect. When a sound is reproduced in close proximity to a flat surface (ideally one of greater linear dimension than the wavelength of the lowest frequency within the sound) then reflections of the sound from the surface have the effect of reinforcing the sound across the surface. As such sound pressure levels away from the sound source reduce at a lower level than the theoretical inverse square law which applies in free air. In practice the acoustic level of the difference signal transmitted via the elongate apertures 4 is enhanced, by around 8 to 10 dB. This helps overcome some of the inherent performance limitations of dipole loudspeakers and enhances the depth and width effect on the reproduced sound.

Further, the elongate apertures 4 serve as ports which spread the available sound signal across any adjacent surface and thus enhance the free surface effect.

Performance improvements are also obtained through processing of the incoming sound signal. Reproduction of low frequency sounds by the dipole loudspeaker is poor compared to that of the mono loudspeaker. This is because, despite the presence of the duct 11, significant cancellation of low frequencies occurs. This is to be expected for low frequencies due to their inherently long wavelengths. To produce a duct of sufficient length to significantly reduce interference between the out of phase signals at low frequencies is impractical. Instead poor reproduction of low frequencies by the dipole loudspeaker is compensated for by boosting the amplitude of low frequencies in the sum signal driving the mono loudspeaker 8. This in turn enables low frequencies to be cut out of the difference signal by means of the high pass filter 21, improving the integrity of the audio difference signal.

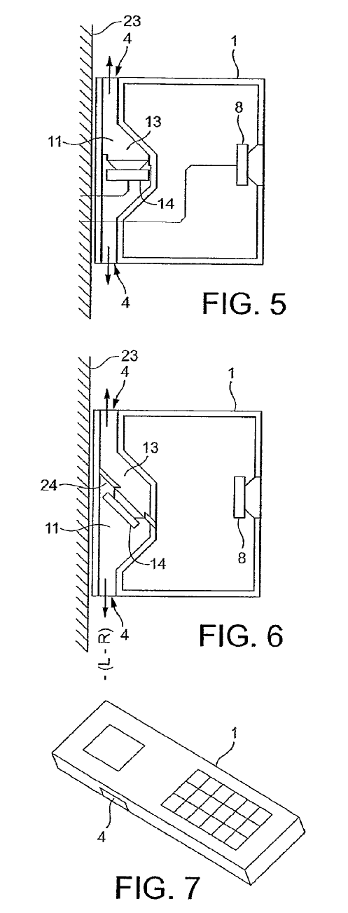

Referring now to FIGS. 5 and 6, these each illustrate alternative embodiments of a sum and difference loudspeaker unit similar to that of FIGS. 1 to 4. The primary difference is that the units of FIGS. 5 and 6 are intended to be used in a different orientation to that of FIGS. 1 to 4, specifically so that the output of the dipole loudspeaker 14, via elongate apertures (or ports) 4 can interact with an upright flat surface 23 such as a wall. In this arrangement the mono loudspeaker 8 will be forward facing, i.e. facing away form the wall 23. However, an alternative arrangement is possible when the mono loudspeaker faces upward; i.e. facing a direction parallel to the surface of the wall 23, but substantially at right angles to the axis of the duct 13.

The embodiment of FIG. 6 differs to that of FIG. 5 in that the dipole loudspeaker 14 is installed in a baffle 24 disposed at a slanted angle in the duct 13. This enables a larger loudspeaker to be fitted in the duct than is the case if the loudspeaker is installed generally perpendicular to the axis of the duct 13. In sound reproduction larger loudspeakers are generally preferred. Certainly, when working at small scales a small increase in the size can bring significant improvements in sound quality.

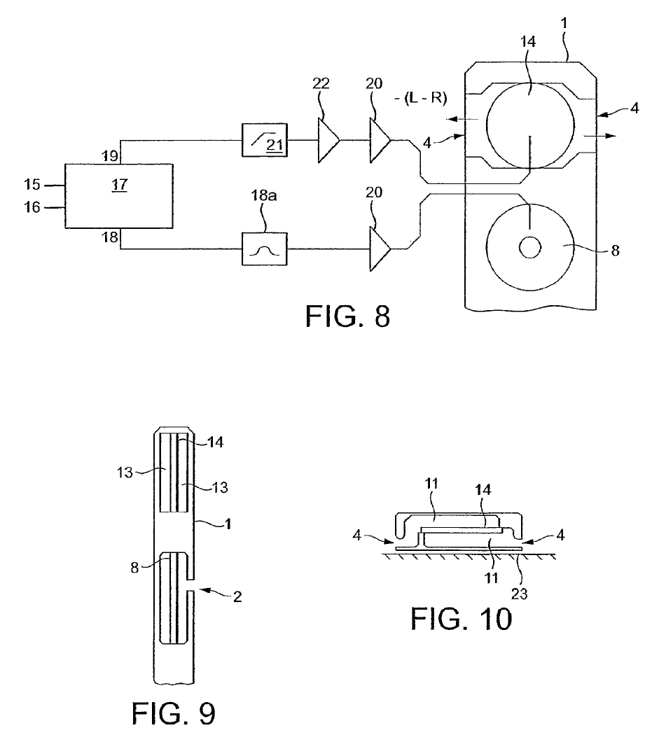

Referring now to FIGS. 7 to 10, these illustrate a sum and difference loudspeaker arrangement incorporated into the handset of a mobile telephone. It will be appreciated, however, that the loudspeaker arrangement could be incorporated into other similarly dimensioned apparatus, and to apparatus with similar proportions but of a different scale for example MP3 players, hand held computers, other hand held electronic equipment and flat screen television sets and monitors.

Akin to the embodiments discussed above, the housing 1 of a telephone handset houses electronic circuitry, similar to that described in relation to FIG. 2, for driving mono 8 and dipole 14 loudspeakers. The loudspeakers are of a “button” type, having an almost flat diaphragm to enable them to be accommodated in a relatively slim housing intended to be held in the hand. The mono loudspeaker 8 is disposed in a cavity in the housing. An aperture 2 is formed in the top of the housing and opens into the cavity. The remainder of the cavity is closed. The mono loudspeaker 8 is arranged to transmit an audio signal through the cavity 2. The loudspeaker 8 may also serve as an earpiece during use of the handset to make telephone calls.

The dipole loudspeaker 14 lies adjacent, but spaced apart, from the mono loudspeaker 8 in substantially the same plane as the mono loudspeaker. The dipole loudspeaker is disposed in a cavity which it divides into two separate portions each of which serve as a duct 13, one extending above and the other below the dipole loudspeaker 14. Each of the two ports of the duct 13 communicated with a respective elongate aperture 4 or port disposed on opposite lateral sides of the handset with a long edge adjacent the underside of the handset.

In use to broadcast a stereo audio signal the handset is placed onto a flat surface, such that the elongate apertures lie adjacent to the surface and the aperture 2 associated with the mono loudspeaker 8 is directed upwards. This enables the surface effect to be exploited.

By arranging the two loudspeakers in substantially the same plane it is possible to use two loudspeakers of a similar size whilst maximizing the size of loudspeakers used.

Because of the necessarily restrictive size of a telephone handset or of other hand held equipment were the two loudspeakers to be accommodated in different orientations (particularly at right angles to each other) at least one loudspeaker would have to be of considerably smaller size, significantly impairing sound quality.

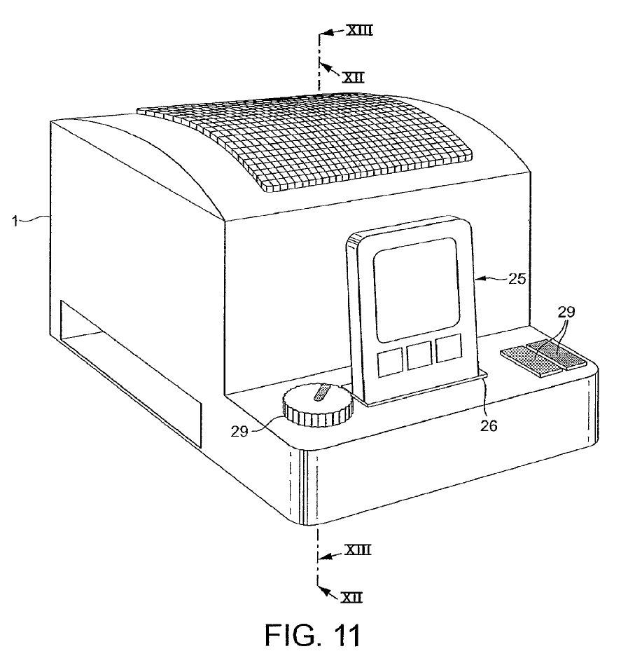

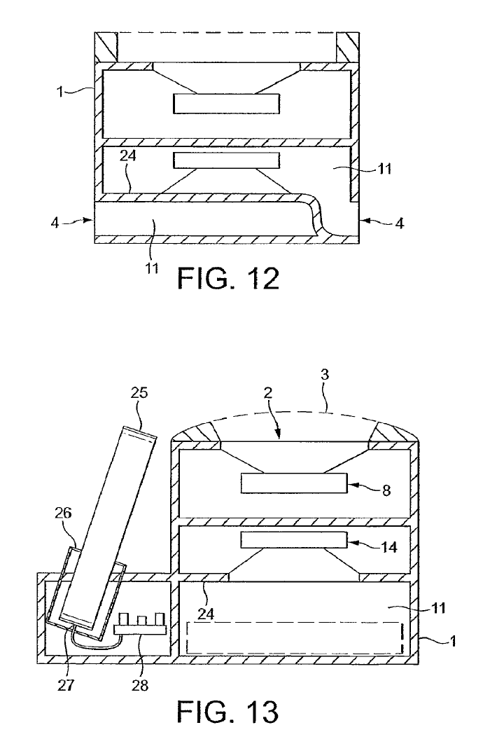

Referring to FIGS. 11, 12 and 13 there is shown a docking station, for removably receiving a portable music player such as an MP3 player 25. The docking station could, however, be adapted for receiving any other appropriate device capable of producing an output, such as a mobile (cell) telephone handset.

The docking station includes an aperture 26 for receiving an MP3 player or other device. Electrical contacts 27 are disposed in the aperture for contacting corresponding contacts of an MP3 player or other device, and connecting it to an electronic circuit 28 housed in the docking station for driving loudspeakers housed in the docking station. User operable controls 29, such as an on/off switch and volume control, are provided on the docking station. Docking stations are of course known and their general requirements understood and will therefore not be described in further detail.

Where the illustrated docking station differs from conventional docking stations is that it incorporates apparatus for reproducing a stereo sound according to the invention. The electronic circuit 28 comprises an arrangement equivalent to that shown in FIG. 2 capable of providing sum and difference outputs. These outputs drive respective loudspeakers 8 and 14 disposed in a housing 1. The first loudspeaker 8, driven by the sum signal, is mounted below an aperture 2 in the top of the housing, and across which extends a substantially transparent to sound cover 3. A duct 11 is provided in the region beneath the first loudspeaker. The duct 11 connects elongate rectangular openings or ports 4 formed in opposite sidewalls of the docking station with a long edge adjacent the lower edge of the respective side wall so that each elongate opening lies adjacent any flat surface on which the docking station is placed. A baffle 24 in which the second loudspeaker 14 is fitted extends in the duct such that one side of the loudspeaker is in communication with one elongate opening 4, via the duct 11, and the opposite side of the loudspeaker 14 is in communication with the other elongate opening 4.

In use the MP3 player provides a two channel stereo output. The electronic circuit 28 in the docking station provides signals containing the sum of the two channels and the difference of the two channels, and these drive the first 8 and second 14 loudspeakers respectively. Thus a mono, sum, audio signal is transmitted by the first loudspeaker 8 via the aperture 2 in the top of the housing 1, and out of phase difference signals are transmitted by the second loudspeaker 14 via respective elongate apertures 4 and 5. Thus stereo sound is produced, with the various advantages of the invention as described above.

The above embodiments are described by way of example only, many variations are possible without departing from the invention.

1. Apparatus for reproduction of stereo sound comprising a transducer for reproducing two audio signals, substantially out of phase with each other, from a single input and means associated with the transducer to conduct at least one of the two audio signals to a location such that the two substantially out of phase signals are transmitted from respective spaced apart locations.

2. Apparatus as claimed in claim 1, wherein the transducer is a bi-directional loudspeaker.

3. Apparatus as claimed in claim 2, wherein the transducer is a dipole loudspeaker.

4. Apparatus as claimed in claim 1, wherein the substantially out of phase signals are transmitted in substantially opposite directions.

5. Apparatus as claimed in claim 1, wherein the means associated with the transducer for conducting at least one of the audio signals is a duct.

6. Apparatus as claimed in claim 5, wherein the transducer is disposed in the duct, the duct having two openings, and arranged such that one out of phase signal is transmitted via one of the openings and the other out of phase signal is transmitted via the other opening.

7. Apparatus as claimed in claim 6, wherein the cross-sectional area of the openings is less than that of the remainder of the duct.

8. Apparatus as claimed in claim 1 comprising a housing, the housing having two openings via which the two out of phase signals are transmitted, respectively.

9. Apparatus as claimed in claim 8, wherein the housing is arranged to be placed on or adjacent a flat surface, and the openings are disposed on the housing such that when the housing is placed on or adjacent a flat surface, the openings lie adjacent that surface.

10. Apparatus as claimed in claim 8, wherein the housing comprises a flat surface or surfaces extending from adjacent the or each opening.

11. Apparatus as claimed in claim 8, wherein the openings are elongate, and at least one long edge of each opening is substantially straight and disposed adjacent one edge of the housing.

12. Apparatus as claimed in claim 11, wherein the ratio of length to width of the opening is in the range 10:1 to 2:1.

13. Apparatus as claimed in claim 11, wherein the ratio of length to width of the opening is in the range 5:1 to 3:1.

14. Apparatus as claimed in claim 1 comprising a second transducer for reproducing a second audio signal.

15. Apparatus as claimed in claim 14, wherein the second transducer is a loudspeaker and is arranged to transmit a signal in a direction between those of the two out of phase signals.

16. Apparatus as claimed in claim 15, wherein the two out of phase signals are transmitted in opposite directions along the same axis and the second transducer is arranged to transmit an audio signal in a direction substantially perpendicular to that axis.

17. Apparatus as claimed in claim 14 arranged to reproduce a two channel stereo audio signal using the sum and difference system wherein the transducer for reproducing two out of phase signals is driven with a signal comprising the difference of the two stereo channels and the second transducer is driven with a signal comprising the sum of the two stereo channels.

18. Apparatus as claimed in claim 18 comprising a sum and difference matrix.

19. Apparatus as claimed in claim 17 comprising a high pass filter arranged to reduce the amplitude of low frequencies in the signal comprising the difference of the two stereo channels.

20. Apparatus as claimed in claim 17 comprising a bass lift compensation circuit arranged to boost the amplitude of low frequencies in the signal comprising the sum of the two stereo channels.

21. Apparatus as claimed in claim 1 comprised in a hand held device.

22. Apparatus as claimed in claim 21, wherein the hand held device is one of a mobile telephone handset, audio player, hand held computer, communicator or pager.

23. Apparatus as claimed in claim 21 comprising a second transducer and wherein the hand held device is generally flat and elongate with a major plane extending through the device and both transducers lie substantially parallel to the major plane of the device.

24. Apparatus as claimed in claim 23, wherein one transducer is arranged so that the two out of phase signals are directed to respective ports on opposite sides of the device.

25. Apparatus as claimed in claim 8 wherein the housing is arranged to receive a device intended to provide a stereo signal to drive the transducers.

26. A method of reproducing stereo sound comprising the steps of: providing a transducer; driving the transducer with a signal input, thereby to produce two audio outputs substantially out of phase with each other; providing means for conducting an audio signal and associating it with the transducer to conduct one of the two out of phase signals to a location such that the two out of phase signals are transmitted from respective spaced apart locations.

27. A method as claimed in claim 26, wherein the two out of phase signals are each transmitted across a substantially flat surface, so that the surface effect can be exploited.

28. A method as claimed in claim 26 comprising the step of providing a second transducer and transmitting a second audio signal using the second transducer.

29. A method as claimed in claim 28, wherein the two out of phase signals are transmitted in opposite directions along substantially the same axis and the second audio signal is transmitted in a direction substantially perpendicular to that axis.

30. A method as claimed in claim 29, wherein the sound is reproduced from a conventional two channel stereo signal comprising the steps of: subtracting one channel of the stereo signal from the other and driving the transducer for reproducing two out of phase signals with the resultant signal, and adding the two channels of the stereo signal to each other and driving the second transducer with the resultant signal.

31. A method as claimed in claim 30, further comprising the step of filtering the difference of the two audio channels to reduce the amplitude of low frequencies in the resulting signal.

32. A method as claimed in claim 30 further comprising the step of boosting the amplitude of low frequencies in the sum of the two audio channels.
